(19) United States
(12) Patent Application Publication
(10) Pub. No.: US 2004/0258998 A1
(43) Pub. Date: Dec. 23, 2004

(54) Electrolytic cell and manufacturing process thereof

(76) Inventor: Alain Vallee, Varennes (CA)

Correspondence Address: DOWELL & DOWELL PC, 2111 Eisenhower Ave., Suite 406, Alexandria, VA, 22314, US

(21) Appl. No.: 10/857,448

(22) Filed: Jun. 1, 2004

Related U.S. Application Data
(60) Provisional application No. 60/474,959, filed on Jun. 3, 2003.

(51) Int. Cl. H01M 4/66; H01M 4/62; B05D 5/12

(52) U.S. Cl. 429/245; 429/232; 427/126.1

(57) ABSTRACT

An electrolytic cell is disclosed which comprises:

an electrolyte; a first electrode and a second electrode;

a primer comprising metal polysilicate and an electrically conductive metal filler, applied to at least one of the first and second electrodes, wherein the primer is chemically and electrochemically stable and electronically conductive; wherein at least one of the first electrode and the second electrode includes a current collector, the primer and an active material; the primer being operatively applied to the current collector, and, the active material being operatively applied to the primed surface(s) of the current collector.

### FIELD OF THE INVENTION

The present invention relates in general to electrolytic cells and, more particularly, to an electrolytic cell and the associated process for the formation of an electrolytic cell, wherein a primer comprised of metal silicate and electrically conductive metal filler is placed between the current collector and the electrode active material to substantially reduce contact resistance and consequently increase columbic efficiency while providing excellent electrochemical/chemical stability.

### BACKGROUND OF THE INVENTION

Rechargeable, or secondary cells, have been known in the art for many years. Furthermore, secondary cells constructed with a primer placed between the current collector and the active material have likewise been known in the art. (See for example, U.S. Pat. No. 5,262,254 to Koksbang, et al.) Although such lithium rechargeable batteries have proven to be functional, they have not solved the problem of relatively high interfacial resistance between the electrode active material and the current collector. Indeed, it is well known that the power density and cycle life of such rechargeable batteries is reduced due to this increased level of cell resistance.

The electrode current collector of an electrolytic cell serves the primary function of conducting the flow of electrons between the active material of the electrode and the battery terminals. Fluctuations in the surface contacts between the active material and the current collector, therefore, increase the internal resistance of an electrolytic cell thereby decreasing both cycle life and power density. Therefore, what is needed, is an interface or “primer” layer between the current collector and the electrode active material which will promote and maintain contact between the electrode active material and the current collector so as to minimize the internal resistance of the cell.

In order to decrease the interfacial resistance between the current collector and the electrode active material, various approaches have been pursued, including chemical and mechanical modifications of the current collector surface layer. Although such modifications have proven helpful, they exhibited high levels of interfacial resistance due to inadequate mechanical and electrical contact between the current collector and the electrode active material as well as the inability to increase electronic conductivity. Furthermore, because of their chemical composition, these modifications have been limited to use on only one of the two electrodes, usually the anode.

Although the prior art does disclose the use of a primer, none of said art discloses the use of an alkali metal silicate and electrically conductive metal filler such as metal nitride, carbide or oxide particles based primer to reduce contact resistance and to enhance the columbic efficiency of the cell while providing excellent chemical/electrochemical stability. U.S. Pat. No. 5,262,254 (“'254 patent”) to Koksbang, et al. discloses the use of a carbon based primer on the positive electrode current collector which prevents corrosion to the positive electrode current collector from the electrolyte. Furthermore, the '254 patent requires that the carbon based primer contain one or more conductive polymers and is only applied to the positive electrode current collector. Accordingly, while the use of the carbon/polymer primer in Koksbang, et al. serves to prevent corrosion of the positive electrode current collector—it does not utilize a primer comprised of electrically conductive metal filler such as metal nitride, carbide or oxide particles and a metal polysilicate, nor is the primer in Koksbang et al. capable of serving as a means of reducing contact resistance and consequently increasing columbic efficiency in either or both of the positive or negative electrodes.

European Patent Application 93, 111,938.2 discloses the use of a lithium silicate in conjunction with both carbon and a binder for use solely as the anode active material. The lithium silicate serves to absorb and release lithium ions during cell operation by electrochemical reactions in a nonaqueous electrolyte.

It is thus an object of the present invention to provide an electrolytic cell having a primer composed of an alkali metal polysilicate and electrically conductive metal filler, without a binder, which is operatively placed between the electrode active material and its current collector.

It is also an object of the present invention to provide an electrolytic cell having a primer which is chemically and electrochemically stable so as to reduce contact resistance and consequently enhance the columbic efficiency of an electrolytic cell.

It is still further an object of the present invention to provide an electrolytic cell wherein a primer compound of an alkali metal polysilicate and electrically conductive metal filler is applied to one or both of an anode and cathode current collector.

These and other objects of the present invention will become apparent in light of the attached Specification, claims, and Drawings.

### SUMMARY OF THE INVENTION

The present invention comprises an electrolytic cell (or rechargeable battery) having an electrolyte, a first electrode and a second electrode, and a primer comprising an alkali metal polysilicate and electrically conductive metal filler which is chemically and electrochemically stable and electronically conductive and which is applied to at least one of the first and second electrode current collectors.

In a preferred embodiment of the electrolytic cell, the first electrode is a cathode and the second electrode is an anode. In addition, the primer may be applied to both the cathode and the anode current collector.

In another preferred embodiment of the electrolytic cell, the first electrode and the second electrode comprise a current collector and an active material. The primer is applied to the current collector and the active material is then operatively applied to the primed surfaces and the current collector. Also, the alkali metal polysilicate includes lithium polysilicate or potassium polysilicate.

In a preferred embodiment of the electrolytic cell, the metal polysilicate is of the general formula MxSiyOz wherein M is an alkali metal, such as lithium or potassium. Furthermore, the primer includes electrically conductive metal filler such as ultra fine metal powders, metal nitride, metal carbide or metal oxide particles. Metal based fillers are inherently more conductive than the carbon or graphite fillers typically used as conductive additives in electrochemical cell. Furthermore Metal based fillers provide improved thermal conduction properties to the primer over carbon based additive such that heat generated by the electrochemical cell is more easily extracted from the electrochemical cell. Conductive metal filler is understood to mean any metallic filler added to the primer in order to increase the electrical conductivity of the primer and may include combinations of various metals, combinations of metal particles and carbon or graphite particles, as well as combinations of metal particles and non-conductive particles.

The metal nitrides are selected from the group consisting of Aluminium Nitride (AlN), Titanium Nitride (TiN), Gallium Nitride (GaN), Boron Nitride (BN), Lithium Nitride (Li3N), Iron Nitride (FeN) and Zirconium Nitride (ZrN). The metal oxides are selected from metal oxide derived from any suitable metal(s) that form stable oxides. The metal carbides are selected from the group consisting Titanium carbide (TiC), Calcium Carbide (Ca2C) and Silicium Carbide (SiC).

In another preferred embodiment of the electrolytic cell the primer has a thickness less than or equal to 5 microns after it is applied to a corresponding one of the first and second electrode current collectors. Furthermore, in this preferred embodiment, the primer can withstand temperatures up to and including 400 degrees Celsius without causing performance, structural and compositional degradation thereto. Also, the primer is substantially insoluble in the electrolyte.

In a preferred embodiment of the electrolytic cell, one of the first and second electrode current collector is constructed with aluminum. In another preferred embodiment of the electrolytic cell one of the first and second electrode current collector is constructed with copper. And in another preferred embodiment of the electrolytic cell the first electrode current collector is constructed with aluminum and the second electrode current collector is constructed with copper.

A process for fabricating an electrolytic cell comprising the steps of: (1) applying a primer comprising alkali metal polysilicate and electrically conductive metal filler particles to at least one of a first and second electrode current collector, (2) applying an active material; and (3) inserting an electrolyte between the first and second electrodes.

In a preferred embodiment of the process, the process further comprises the step of applying the primer to both the first and second electrode current collectors.

In another preferred embodiment of the process, the primer is of the general formula of MxSiyOz, wherein M is an alkali metal, such as lithium or potassium.

### BRIEF DESCRIPTION OF THE DRAWINGS

FIG. 1 is a schematic diagram of an electrolytic cell, and

FIG. 2 is a schematic diagram of an electrolytic cell.

### BEST MODE FOR PRACTICING THE INVENTION

While this invention is susceptible of embodiment in many different forms, there is shown in the drawings and will herein be described in detail, one specific embodiment with the understanding that the present disclosure is to be considered as an exemplification of the principles of the invention and is not intended to limit the invention to the embodiment illustrated.

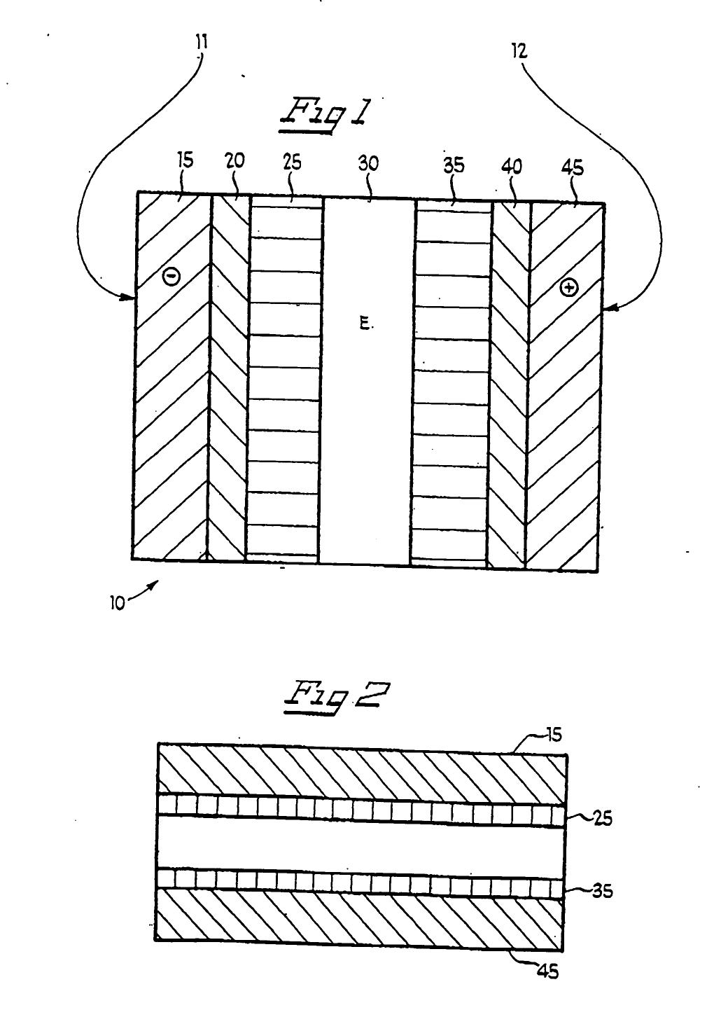

Electrolytic cell 10, which in a preferred embodiment may comprise a rechargeable battery, is shown in FIG. 1 as including negative electrode side 11, electrolyte 30, and positive electrode side 12. The negative electrode side 11 (generally referred to as the anode) includes current collector 15, typically constructed of nickel, iron, stainless steel, and/or copper foil, and a body of negative electrode active material 25. In a preferred embodiment, negative electrode active material 25 consists of lithium, or compounds and alloys thereof—although other materials are also contemplated for use. Positive electrode side 12 (generally referred to as the cathode) includes current collector 45, typically constructed of aluminum, nickel, iron, and/or stainless steel, and a body of positive electrode active material 35. Positive electrode active material 35 is usually different than the negative electrode active material 25. Typical positive electrode active materials may include transition metal oxides, sulfide, and/or electroactive conducting polymer compounds having a reversible lithium insertion ability. Of course, other conventional compounds for use as the active material are also contemplated for use and association with the primer and its corresponding electrode.

A problem associated with rechargeable lithium batteries, as shown in FIG. 2, is the increased cell resistance caused by an inadequate or interrupted interfacial contact between the current collectors, such as current collectors 15, 45, and the electrode active materials, such as electrode active material 25, 35. During the reduction and oxidation reactions that take place within the cell, the electrode active materials 25, 35 shrink and/or expand, pull away from, or lose contact with the current collectors. The loss of contact between the current collectors 15, 45 and the electrode active materials 25, 35 increases cell resistance and thereby decreases power output, columbic efficiency, and cycle life of the cell.

In order to improve interfacial contact between the anode current collector 15 and the anode active materials 25, a primer layer 20, (FIG. 1,) is operatively placed between the anode current collector 15 and the anode active material 25. Also, as will be explained, a second primer layer 40 (FIG. 1) may also be operatively placed between cathode current collector 45 and cathode active material 35.

With respect to anode 11, primer layer 20 may be constructed with a compound of an alkali metal polysilicate and electrically conductive metal, metal nitrides, carbides or oxides particles. For purposes of explanation of the present invention, the metal polysilicate will be described as a alkali metal polysilicate such as lithium polysilicate or potassium polysilicate. However, it will be understood to those with ordinary skill in the art, that the principles associated with the claimed and described invention would also be applicable to any metal polysilicate which had the ability to exhibit chemical/electrochemical stability, adhesion to the metallic current collector and, in combination with ultra fine metal powders metal nitrides, carbides or oxides particles, will electronically conduct electrons of anode active material 25.

As previously mentioned, metal based fillers are inherently more conductive than the carbon or graphite fillers typically used as conductive additives in electrochemical cell such that interfacial resistance between active material and current collector is decreased over prior art primer. Furthermore Metal based fillers provide improved thermal conduction properties to the primer over carbon based additive such that the primer 20 provides an easy thermal path for heat generated by the electrochemical cell. The metal nitrides may be selected from the group consisting of Aluminium Nitride (AlN), Titanium Nitride (TiN), Gallium Nitride (GaN), Boron Nitride (BN), Lithium Nitride (Li3N), Iron Nitride (FeN) and Zirconium Nitride (ZrN). The metal carbides may be selected from the group consisting Titanium carbide (TiC), Calcium Carbide (Ca2C) and Silicium Carbide (SiC).

The metal oxides can be derived from any suitable metal(s) that form stable oxides. Examples of such metals include, for example, aluminum, cadmium, cobalt, copper, chromium, gallium, germanium, gold, indium, iridium, iron, lead, magnesium, molybdenum, manganese, neodymium, nickel, niobium, osmium, palladium, platinum, rhenium, rhodium, ruthenium, tantalum, technetium, tellurium, thallium and tin, titanium, tungsten, strontium, vanadium, zinc, zirconium and mixtures thereof. Particularly preferred are metals that form metal oxides or mixtures of metal oxides with good electrical conductivity. Examples of metal oxides having good conductivity are: monoxides of Cd, Cu, Pb, Ti, V; dioxide of Cu, Cr, Ir, Mn, Mo, Nb, Os, Pb, Re, Rh, Ru, Sn, Ti, V, W; and CrO3, MoO3, WO3, In2O3, Ti2O3, V2O3, Fe3O4, Co3O4, NiCo2O4, MnCo2O4, SrVO3, SrFeO3, SrRuO3, and mixtures thereof.

The metal polysilicate and metal particles primer is prepared by mixing the metal nitrides, carbides or oxides particles into the metal polysilicate to form a homogenous compound and depositing the compound on the surface of the metallic current collector sheet and simultaneously applying heat. The resulting layer is continuous, and is bonded chemically so strongly to the metallic current collector sheet that it cannot be detached by simple physical means. The primer forms a chemical and physical continuum between the metallic current collector sheet facing the positive electrode and the appropriate face of the positive electrode. The preferred thickness of the metal polysilicate and metal particles primer layer ranges from a fraction of a micron (μm) thick to several micron thickness (5-10 μm).

Lithium or potassium polysilicate primer layer 20 are of the general formula Lix Siy Oz or and Kx Siy Oz also includes metal particles which is contemplated to be small particles that do not promote the chemical/electrochemical decomposition of electrolyte 30. It should be noted that primer material 20 does not include a binder material in the alkali metal polysilicate compound because of the excellent adhesion properties of the alkali metal polysilicate and metal particles primer. Indeed, due to the omission of a binder, and more particularly a polymer binder, the polysilicate can be heat treated to extremely high temperatures, such as 400 degrees Celsius, without a concern of degradation of the metal particles or loss of adhesion of the metal particles to the aluminum anode.

It has been found that the use of the present alkali metal polysilicate and metal particles compound exhibits significant advantages which not only increase the cycle life of rechargeable lithium battery 10, but which also reduces contact resistance and consequently increases the columbic efficiency therein as well. For example the lithium or potassium polysilicate and metal particles primer 20, 40 is (1) substantially chemically and electrochemically stable during either oxidation or reduction; (2) is insoluble in the electrolyte which precludes erosion of the interface between the current collector and the active material; (3) is a good electronic conductor, (4) has excellent adhesion to both aluminum and copper current collectors; (5) can be dehydrated at a temperature up to and including 400 degrees Celsius; and (6) is substantially chemically stable with regards to both water and ambient atmosphere which increases its ease of use and application.

In a preferred embodiment of the present invention, a primer layer of metal polysilicate and metal particles is applied to: (1) the anode only, or (2) to both the anode and the cathode to decrease interfacial resistance between the current collector and the electrode active material. The ability to use the metal polysilicate metal particles primer on both the anode and the cathode provides an economical advantage and also increases the ease of manufacturing the cell. The metal polysilicate metal particles primer dehydrates at a temperature less than or equal to 500 degrees Celsius, which allows the primer to be directly placed onto the current collector surface and subsequently heat cured without risk of degradation to the underlying aluminum or copper current collectors. Furthermore, because the primer can be prepared in an aqueous solution there is no need for the use of an organic solvent.

In one specific embodiment, the primer layer of metal polysilicate and metal particles is free of carbon or graphite.

In another preferred embodiment of the present invention, a primer layer of metal polysilicate and metal particles is applied only to the cathode current collector and the anode is made of lithium metal which does not require a separate current collector; Thereby decreasing interfacial resistance between the cathode current collector and the cathode active material. The benefits of the above-identified exhibited characteristics of primer layer 20 and 40 are decreased interfacial resistance between the electrode active material and current collector and improved chemical/electrochemical stability.

Although the present invention has been described in relation to particular variations thereof, other variation and modifications are contemplated and are within the scope of the present invention. Therefore the present invention is not to be limited by the above description but is defined by the appended claims.

We claim:

1. An electrolytic cell comprising:
an electrolyte;
a first electrode and a second electrode;
a primer comprising metal polysilicate and electrically conductive metal filler, applied to at least one of the first and second electrodes, wherein the primer is chemically and electrochemically stable and electronically conductive;
wherein at least one of the first electrode and the second electrode includes a current collector, the primer and an active material;
the primer being operatively applied to the current collector, and, the active material being operatively applied to the primed surface(s) of the current collector.

2. The electrolytic cell according to claim 1, wherein the first electrode is a cathode and the second electrode is an anode.

3. The electrolytic cell according to claim 2, wherein the first and second electrodes include a cathode and an anode current collector, respectively, the primer is applied to both the cathode and the anode current collector.

4. The electrolytic cell according to claim 2, wherein the first electrodes include a cathode current collector, the primer is applied to the cathode and current collector.

5. The electrolytic cell according to claim 1, wherein the metal polysilicate is selected from the group consisting of lithium polysilicate and potassium polysilicate.

6. The electrolytic cell according to claim 1 wherein the metal polysilicate is of the general formula Mx Siy Oz wherein M is an alkali metal.

7. The electrolytic cell according to claim 6 wherein the alkali metal is selected from the group consisting of lithium and potassium.

8. The electrolytic cell according to claim 1, wherein the primer includes an electrically conductive metal filler selected from the group consisting of ultra fine metal powders, metal nitrides particles, metal carbides particles and metal oxides particles.

9. The electrolytic cell according to claim 1, wherein the primer has a thickness less than or equal to 5 microns after it is applied to a corresponding one of the first and second electrodes.

10. The electrolytic cell according to claim 1, wherein the primer includes means for precluding excessive structural degradation upon exposure to temperatures up to and including 400 degrees Celsius, wherein the precluding means includes the metal polysilicate.

11. The electrolytic cell according to claim 1, wherein the primer is substantially insoluble in the electrolyte.

12. The electrolytic cell according to claim 1, wherein one of the first and second electrodes is constructed with aluminum.

13. The electrolytic cell according to claim 1, wherein one of the first and second electrodes is constructed with copper.

14. The electrolytic cell according to claim 1, wherein the first electrode is constructed with aluminum and the second electrode is constructed with copper.

15. The electrolytic cell according to claim 1, wherein the primer is free of carbon or graphite.

16. A process for fabricating an electrolytic cell comprising the steps of:
applying a primer comprising metal polysilicate and electrically conductive metal filler to a current collector of at least one of a first and second electrode;
applying an active material to the primer; and
inserting an electrolyte between the first and second electrodes.

17. The process according to claim 15, further comprising the step of applying the primer to both the first and second electrodes.

18. The process according to claim 15, wherein the primer is of the general formula of Mx Siy Oz, wherein M is an alkali metal.

19. The electrolytic cell according to claim 17 wherein the alkali metal is selected from the group consisting of lithium and potassium.
